(19) United States
(12) Patent Application Publication
(10) Pub. No.: US 2020/0127340 A1
(43) Pub. Date: Apr. 23, 2020

(54) BATTERY PACKS FOR POWER TOOLS

(71) Applicant: Ridge Tool Company, Elyria, OH (US)

(72) Inventor: Harald Krondorfer, Aurora, OH (US)

(21) Appl. No.: 16/529,984

(22) Filed: Aug. 2, 2019

Related U.S. Application Data
(60) Provisional application No. 62/747,696, filed on Oct. 19, 2018.
(60) Provisional application No. 62/801,210, filed on Feb. 5, 2019.

(51) Int. Cl. H01M 10/44; B25F 5/02; H02K 11/33; H02K 7/14; H01M 10/46; H01M 2/10; H02J 7/00

(52) U.S. Cl. CPC H01M 10/441; B25F 5/02; H02K 11/33; H02K 7/145; H01M 2220/30; H01M 2/1055; H02J 7/0027; H02J 7/0044; H02J 7/007; H01M 10/46

(57) ABSTRACT

Battery packs for power tools are described. The battery packs utilize lithium cells with solid electrolytes. Also described are power tools using the battery packs. Systems of the battery packs with power tools and chargers are also described.

### CROSS REFERENCES TO RELATED APPLICATIONS

This application claims priority from U.S. provisional application Ser. No. 62/801,210 filed on Feb. 5, 2019. This application also claims priority from U.S. provisional application Ser. No. 62/747,696 filed Oct. 19, 2018.

### FIELD

The present subject matter relates to battery packs for power tools using lithium cells with solid electrolytes.

### BACKGROUND

Battery powered tools have become a standard for do-it-yourself and professional applications. Many such tools use lithium ion batteries. Lithium ion batteries provide good energy density, which translates into long run times and low battery volumes and weight. In addition, modern lithium ion batteries can sustain high discharging current rates such as greater than 5 C to support the power requirements of most tools. Modern lithium ion batteries can also be charged at high rates of greater than 2 C.

One drawback of modern lithium ion batteries is the use of a liquid organic electrolyte. These electrolytes are flammable and as a result, stringent transportation rules apply to Li-ion batteries. These transportation rules make it cost prohibitive to ship high capacity battery packs by air. In a global economy with globally operating companies, this has become a major disadvantage of Li-ion batteries. With ever increasing demands for higher battery capacity and with the production of batteries concentrated in several locations, the need for a new battery technology with inherently non-flammable components has become significant.

In view of these and other concerns, it would be beneficial to provide a portable electrical power source which could provide the relatively high discharge current rate required for most power tools, which was free of issues relating to flammability. It would also be desirable to provide a portable electrical power source which could be easily and inexpensively shipped by air.

### SUMMARY

The difficulties and drawbacks associated with currently known products are addressed in the present subject matter as follows.

In one aspect, the present subject matter provides a battery pack for use with an electrically powered tool. The battery pack comprises a housing defining a generally hollow interior, at least one lithium solid state electrolyte battery cell disposed in the hollow interior defined in the housing, and an interface for electrically connecting the battery pack to at least one of a tool and a charger.

In another aspect, the present subject matter provides a system comprising at least one of an electrically powered device and a charger, and a battery pack including a housing defining a generally hollow interior, at least one lithium solid state electrolyte battery cell disposed in the hollow interior defined in the housing, and an interface for electrically connecting the battery pack to both the electrically powered device and the charger, separately.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 is a schematic illustration of an embodiment of a battery pack in accordance with the present subject matter.

FIG. 2 illustrates a battery powered tool using an embodiment of a battery pack in accordance with the present subject matter.

FIG. 3 is a perspective illustration of another battery powered tool using an embodiment of a battery pack in accordance with the present subject matter.

FIG. 4 is a detailed perspective view of the battery pack shown in FIG. 3.

FIG. 5 is a perspective view of a typical charger used in association with the battery packs of the present subject matter.

FIG. 6 illustrates an operation of engaging an embodiment of a battery pack with a charger.

FIG. 7 illustrates the battery pack engaged with the charger of FIG. 6.

FIG. 8 illustrates an operation of engaging an embodiment of a battery pack with a tool.

FIG. 9 illustrates a further operation of engaging an embodiment of a battery pack with the tool in FIG. 8.

FIG. 10 illustrates another battery powered tool using an embodiment of a battery pack in accordance with the present subject matter.

FIG. 11 illustrates another battery powered tool using an embodiment of a battery pack in accordance with the present subject matter.

FIG. 12 illustrates another battery powered tool using an embodiment of a battery pack in accordance with the present subject matter.

FIG. 13 illustrates another battery powered tool using an embodiment of a battery pack in accordance with the present subject matter.

FIG. 14 illustrates another battery powered tool using an embodiment of a battery pack in accordance with the present subject matter.

FIG. 15 illustrates another battery powered tool using an embodiment of a battery pack in accordance with the present subject matter.

FIG. 16 is a perspective illustration of another battery pack in accordance with the present subject matter.

FIG. 17 is a perspective illustration of another battery pack in accordance with the present subject matter.

FIG. 18 is a schematic exploded view of the battery pack depicted in FIG. 16.

FIG. 19 is a schematic exploded view of the battery pack shown in FIG. 17.

### DETAILED DESCRIPTION OF THE EMBODIMENTS

Modern battery operated power tools such as drill drivers, saws, grinders, or press tools for example use either internal rechargeable lithium ion (Li-ion) batteries or Li-ion battery packs that can be separated from the power tool. While the tool with an internal battery generally cannot be used during the charging cycle, separable battery packs can be charged independently from the tool. Separable battery packs are typically designed to fit an entire family of compatible tools. Because of these advantages, tools with internal Li-ion batteries are typically limited to small stand-alone tools, while the vast majority of power tools are powered by a separable battery pack.

A battery pack typically contains one or more battery cells. The electrical configuration of these cells can be in series or in parallel. Simply put, series configuration of cells increases the total output voltage of the battery pack, and parallel configuration increases the possible discharge current for the battery pack. The total number of battery cells and the capacity of the utilized battery cells determine the total energy capacity in Watt-Hours (Wh) of the battery pack. The present subject matter also includes battery packs in which a portion of the cells in the battery pack are arranged in series and another portion of the cells in the battery pack are arranged in parallel.

Before turning attention to the present subject matter, it is instructive to describe discharge current and C-rate. In describing batteries, discharge current is often expressed as a C-rate in order to normalize against battery capacity, which is often very different between batteries. A C-rate is a measure of the rate at which a battery is discharged relative to its maximum capacity. A 1C rate means that the discharge current will discharge the entire battery in 1 hour. For a battery with a capacity of 10 amp-hrs, this equates to a discharge current of 10 amps. A 5C rate for this battery would be 50 amps, and a C/2 rate would be 5 amps. Charge rates are typically also expressed as C-rates. Charge rates are typically lower than discharge rates.

### Battery Packs, Power Tools, and Chargers

The present subject matter provides battery packs utilizing cells with lithium based chemistry using solid electrolytes. The cells used in the battery packs are lithium cells with solid electrolytes. These cells are referred to herein as lithium solid state electrolyte cells, lithium solid state cells, or variations thereof. Details of the lithium cells are provided herein. The battery packs of the present subject matter comprise one or more lithium solid state electrolyte battery cells, in a serial or parallel configuration. It is also contemplated that both configurations could be utilized. The peak output voltage of the battery pack is between 3V and 120V, depending on the cell configuration. Typically, the peak output voltage of a single cell with lithium based chemistry using a solid electrolyte is 4V. However, the present subject matter includes battery packs providing peak output voltages outside of this range. The battery pack also comprises a housing to hold the cells, optional electronic circuitry to control the charging and/or discharging of the cells which can be a battery management system as described in greater detail herein, and an interface to the tool and a charger. The interface includes electrical contacts for power (+/−). These electrical contacts transfer electrical power from the cells in the battery pack to a power tool for example, and can also transfer electrical power to the cells in the battery pack such as from a charger. The interface can also include one or more electrical contacts and/or electrical components for the battery management system to communicate with the power tool or the charger. These contacts may include, but are not limited to temperature sensors, data contacts, ID resistors, etc. These components may also be provided in association with the electronic circuitry.

The electronic circuitry and typically the battery management system monitors critical parameters of the battery pack and controls the charging and/or discharging process to best suit the cell chemistry and to maximize the usable life of the battery pack. The electronic circuitry can be electrically connected to one or more battery cells disposed in the battery pack, and can be electrically connected to one or more battery terminals of the battery pack. In some embodiments, the electronic circuitry can include components to enhance the performance of the battery pack. In some embodiments, the electronic circuitry can include components to monitor battery characteristics, to provide voltage detection, to store battery characteristics, to display battery characteristics, to inform a user of certain battery characteristics, to suspend current within the battery, to detect temperature of the battery pack, battery cells, and the like, to transfer heat from and/or within the battery pack, and to provide balancing methods when an imbalance is detected within one or more battery cells. In some embodiments and in some aspects, the electronic circuitry includes one or more of a voltage detection circuit, a boosting circuit, a state of charge indicator, and the like. In some embodiments, the electronic circuitry can be placed on a printed circuit board (PCB). In other embodiments, the electronic circuitry can be placed to a flexible circuit. In some embodiments, the flexible circuit can wrap around one or more cells or wrap around the interior of the housing.

In some embodiments, the electronic circuitry can also include a microprocessor. The microprocessor can monitor various battery pack parameters (for example, battery pack present state of charge, battery cell present state of charge, battery pack temperature, battery cell temperature, and the like), can store various battery pack parameters and characteristics (including battery pack nominal voltage, chemistry, and the like, in addition to the parameters), can control various electrical components within the electronic circuitry, and can conduct communication with other electrical devices, such as, for example, a power tool, a battery charger, and the like. In some embodiments, the microprocessor can monitor the present state of charge of each battery cell and can identify when an imbalance occurs. For example, the present state of charge for a battery cell exceeds the average cell state of charge by a certain amount or drops below the average cell state of charge by a certain amount.

In some embodiments and in some aspects, the electronic circuitry can include a voltage detection circuit. In certain versions, the voltage detection circuit can include a plurality of resistors forming resistor divider networks. Other assemblies and/or circuits are contemplated.

In some embodiments, voltage characteristics of the battery pack and/or of the battery cells can be read by the microprocessor through a plurality of resistors when the microprocessor is in an active mode. In some embodiments, the microprocessor can read, assess, or otherwise determine voltage by turning off transistor(s) (for example, a transistor becomes non-conducting).

In some embodiments, the microprocessor can monitor the voltage of each battery cell and balance the cell or a collection of cells if an imbalance occurs. As previously noted, the battery pack can include the plurality of resistors for providing voltage measurements of the battery cells. The plurality of resistors are arranged such that the microprocessor can measure the voltage of each of the battery cells approximately at the same time. In some embodiments, the microprocessor detects an imbalance within the battery pack. Alternatively or in addition, the microprocessor can be configured to detect a difference in cell voltage between two or more cells in a collection of cells. An imbalance may be designated when the difference in cell voltage exceeds 0.1 V for example.

In some embodiments and in some aspects, the battery pack may re-balance the cells when an imbalance has been detected via a balancing circuit. In some embodiments, the battery pack can re-balance the battery cells when the battery pack is in a discharging operation or act, or when the battery pack is not providing a discharge current or receiving a charge current. In some embodiments, the balancing circuit can include the plurality of resistors and the plurality of transistors. In some embodiments, the microprocessor disables the battery (for example, interrupts battery operation, prevents battery operation, etc.) via a switch when a voltage ratio between cells is no longer included within an acceptable range. After the battery pack is disabled, the microprocessor determines which cell(s) is imbalanced and may designate such as the “low voltage cell”, for further processing or operation(s). Nonlimiting examples of further processing or operations include disabling the battery pack and/or generating an error signal such as on the charger.

The battery pack also can include a locking assembly operable to lock and/or otherwise engage the battery pack to an electrical device, such as, for example, to the power tool and/or to a battery charger. The locking assembly typically includes locking members which are movable between a locked position, in which the locking members engage a corresponding locking member on the electrical device to lock the battery pack to the electrical device, and an unlocked position. When the locking assembly is in the unlocked position, the battery pack can be readily removed and/or disengaged from the electrical device. The locking assembly also includes actuators for moving the locking members between the locked position and the unlocked position. The actuators have a large surface for engagement by an operator to provide improved ease of unlocking the locking assembly. Also, the actuators are supported to reduce the gripping force required to unlock the locking assembly. The battery pack is configured such that upon engagement with the electrical device, and upon positioning the locking assembly in the locked position, electrical communication is also established between the battery pack and the electrical device. Electrical communication includes transfer of electrical power to or from the battery pack and the electrical device and may also include transmittance of electrical signals to assist or enable operation and/or charging, or to provide information to a user.

As previously noted, electrical communication can occur via the previously described electrical contacts of the battery pack and/or interface.

The present subject matter also provides battery packs adapted for particular applications and/or for power tools that draw power according to particular consumption or draw profiles. In some embodiments, the battery pack can be configured for transferring power to and receiving power from various electrical devices, such as, for example, various power tools, battery chargers, and the like. In some embodiments, the battery pack can supply power to various power tools, such as for example, a drill driver, a circular saw, and the like. In some embodiments, the battery pack can power various power tools having high discharge current rates. For example, the battery pack can supply an average discharge current that is equal to or greater than approximately 10 A. In certain embodiments, the battery pack can supply an average discharge current greater than 15 A, in other embodiments greater than 20 A, in other embodiments greater than 25 A, in other embodiments greater than 30 A, in other embodiments greater than 35 A, and in still other embodiments greater than 40 A. It will be understood that the present subject matter includes battery packs that supply an average discharge current that is less than 10 A, such as less than 8 A, less than 6 A, less than 4 A, and less than 2 A. The typical minimum average discharge current for the present subject matter battery packs is about 1 A. However, it will be understood that the present subject matter includes battery packs providing average discharge currents less than 1 A. Thus, in practice, there are no limitations to the minimum discharge current as it can be as low as desired.

The battery packs of the present subject matter typically exhibit a capacity expressed in ampere-hours of at least 1 Ah, in many embodiments at least 2 Ah, in other embodiments at least 3 Ah, in other embodiments at least 4 Ah, in other embodiments at least 5 Ah, in other embodiments at least 6 Ah, in still other embodiments at least 7 Ah, and in particular versions at least 8 Ah or more.

As previously noted, the battery packs of the present subject matter typically provide a peak output voltage within a range of from 3V to 120V. In certain embodiments, the peak output voltage is within a range of from 6V to 60V, and in particular embodiments, the peak output voltage is within a range of from 10V to 36V.

The battery packs of the present subject matter typically include from one to 45 or more lithium solid electrolyte battery cells. In many embodiments, the battery packs include from four to ten lithium solid electrolyte battery cells. However, it will be understood that the present subject matter is not limited to any particular number of battery cells associated with a battery pack.

The present subject matter provides a wide array of electrically powered devices, for example power tools, that are configured to be powered by and engaged with the battery packs described herein. Non-limiting examples of such power tools include rotary drivers, drills, saws, grinders, blowers, press tools, rotary hammers, and lights. Specific nonlimiting examples of rotary drivers include hex and wrench drivers, impact drivers, and the like. Particular examples of drills include but are not limited to pistol grip drills, driver or impact drills, hammer drills, rotary hammers, and the like. Nonlimiting examples of saws include circular saws, reciprocating saws, jigsaws, miter saws, tile saws, metal saws, scroll saws, band saws, chain saws, and the like. Nonlimiting examples of grinders include rotary grinders, wheel grinders, disc grinders, and the like. Nonlimiting examples of blowers include air blowers, leaf blowers, and the like. Leaf blowers include backpack blowers and handheld blowers. Nonlimiting examples of press tools are electrically operated tools that provide a hydraulic circuit typically in the form of an extendable piston or ram that drives a work tool. Nonlimiting examples of lights include halogen and LED lights. The present subject matter also provides a wide array of electrically powered outdoor equipment that are configured to be powered by and engaged with the battery packs described herein. Non-limiting examples of such outdoor equipment include lawn mowers, lawn trimmers, edgers, hedge trimmers, snow blowers, and the like. Nonlimiting examples of lawn trimmers include string trimmers and blade trimmers.

The present subject matter also provides systems of electrically powered devices such as the noted tools in combination with the noted battery packs.

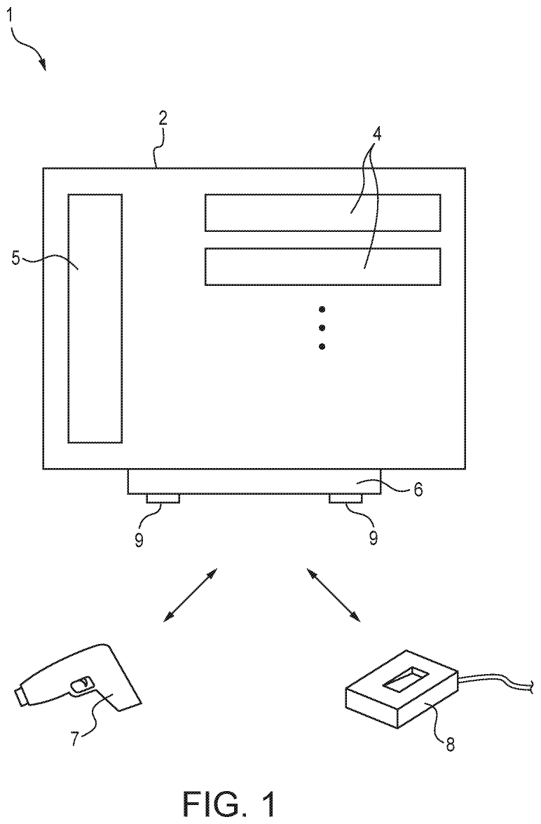

FIG. 1 is a schematic view of an embodiment of a battery pack 1 in accordance with the present subject matter. The battery pack 1 comprises a housing 2, one or more lithium solid electrolyte cells 4 having a solid electrolyte and as described in greater detail herein, and electronic circuitry 5 to control the charging and/or discharging of the cells and for possibly performing additional functions as described herein. The battery pack 1 also comprises an interface 6 adapted to engage one or more tools 7 and a charger 8. The interface 6 and/or the housing 2 includes electrical contacts 9. It will be understood that although FIG. 1 illustrates a drill for the tool 7, the tool could be any of the tools described herein such as but not limited to drivers, saws, grinders, blowers, press tools, and lights.

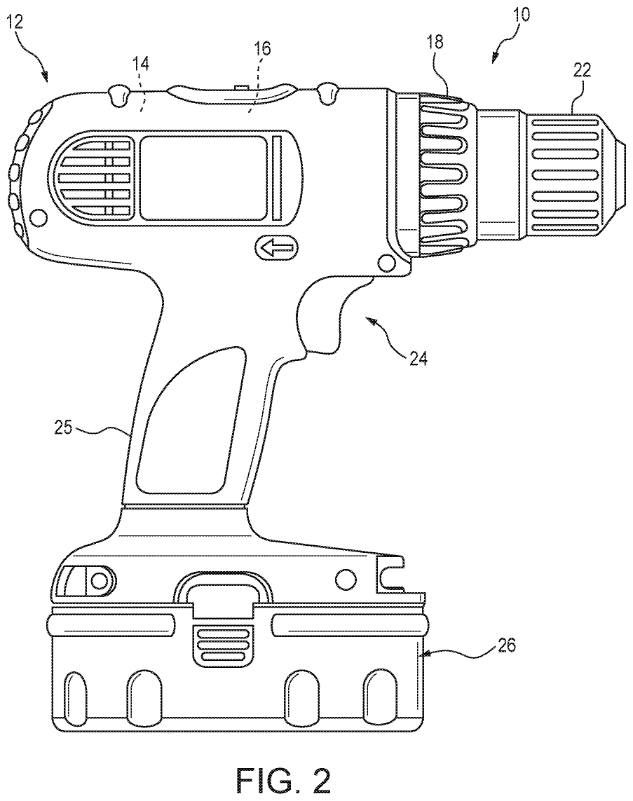

FIG. 2 is a side view of a cordless power tool according to an example embodiment of the present subject matter. Referring to FIG. 2, an example cordless power tool may be generally indicated by reference numeral 10 which designates a drill, and may include a housing 12, a motor assembly 14, a multi-speed transmission assembly 16, a clutch mechanism 18, a chuck 22, a trigger assembly 24, a handle 25 and a battery pack 26. Battery pack 26 may be a rechargeable high power battery pack, such as described herein or other high power source, comprised of one or a plurality of lithium solid state cells, for example. The lithium solid state cells include a solid electrolyte as described herein.

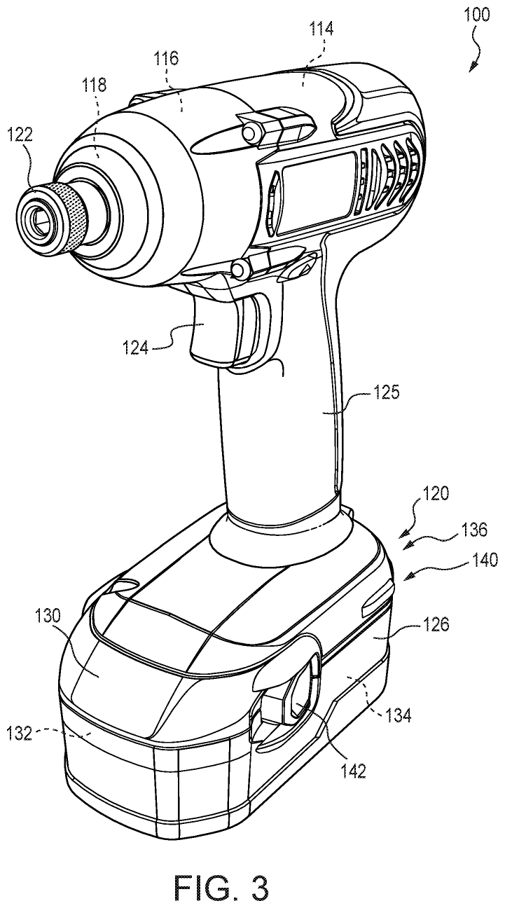

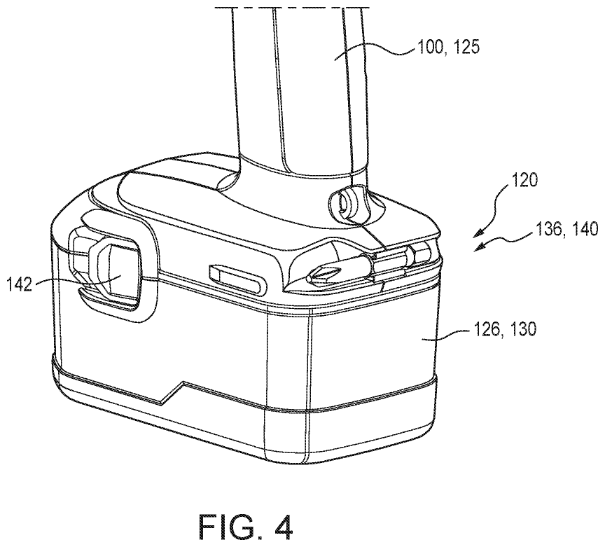

FIG. 3 is a perspective illustration of another battery powered tool using an embodiment of a battery pack in accordance with the present subject matter. FIG. 4 is a detailed perspective view of the battery pack shown in FIG. 3. FIGS. 3 and 4 illustrate a drill 100 comprising a housing 112, a motor assembly 114, a transmission assembly 116, a clutch mechanism 118, a check 122, a trigger 124, a handle 125, and a battery pack 126. The drill 100 also comprises a receiving region 120 for engagement with the battery pack 126. The battery pack 126 includes a housing 130, at least one lithium solid electrolyte battery cell 132 disposed in the housing 130, electronic circuitry 134 as previously described, and an interface 136 for engaging and electrically connecting the battery pack 126 to the drill 100. The battery pack 126 also includes a locking assembly 140 and one or more actuators 142 as described herein.

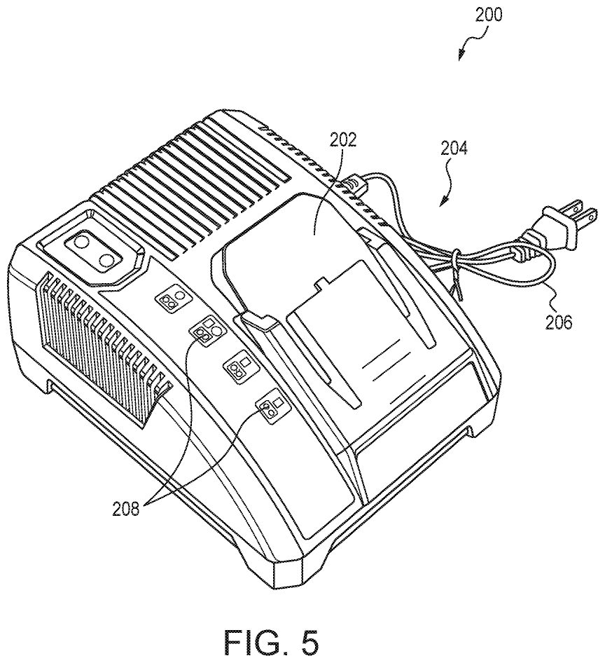

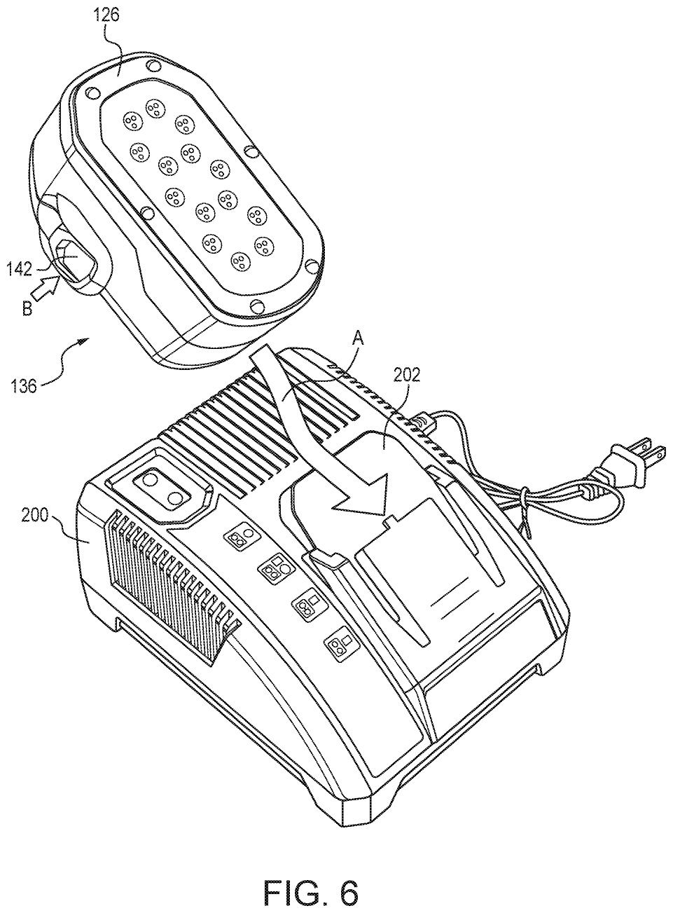

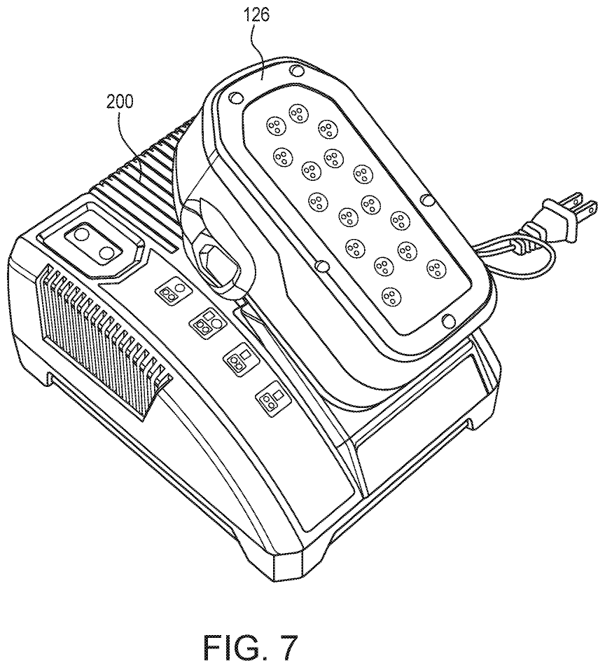

FIG. 5 is a perspective view of a typical charger used in association with the battery packs of the present subject matter. FIG. 6 illustrates an operation of engaging an embodiment of a battery pack with a charger. FIG. 7 illustrates the battery pack engaged with the charger of FIG. 6. In FIGS. 5-7, the charger 200 includes a receiving region 202 which is configured for receiving a battery pack as described herein. The receiving region 202 includes one or more electrical contacts 204 that enable electrical communication with a battery pack when engaged in the receiving region 202. The charger 200 also includes a cord 206 for plugging into an electrical outlet (not shown). The charger 200 may also include one or more indicators 208 providing information to an operator. FIG. 6 shows that in engaging the battery pack 126 with the charger 200, the interface 136 of the battery pack 126 is aligned with the receiving region 202 of the charger 200, as the battery pack 126 is moved toward the charger 200 in the direction of arrow A. If the battery pack 126 includes one or more actuators 142, the actuator(s) 142 may be depressed in the direction of arrow B for example to facilitate engagement of the battery pack 126 with the charger 200. Typically, the actuator(s) or release button is only relevant for engagement with the tool and not used when the battery pack is connected or engaged with the charger. FIG. 7 depicts the battery pack 126 engaged with the charger 200.

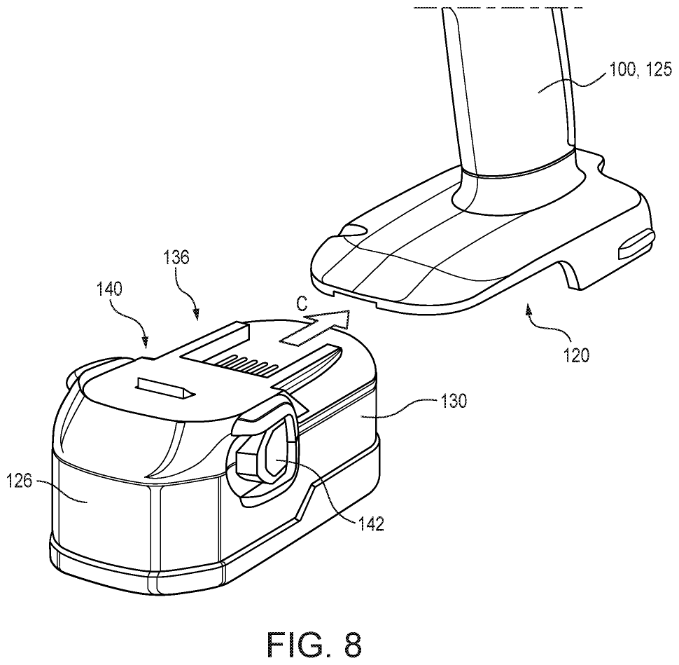

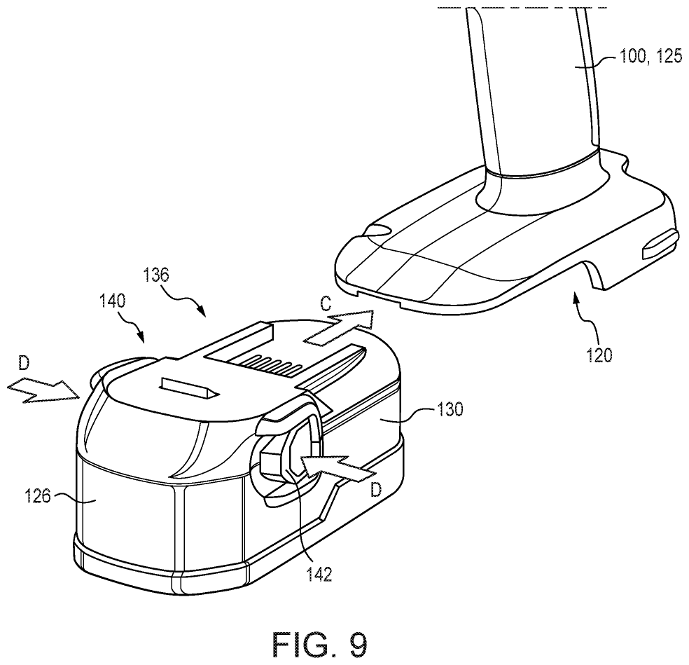

FIG. 8 illustrates an operation of engaging an embodiment of a battery pack with a tool. FIG. 9 illustrates a further operation of engaging the battery pack with the tool in FIG. 8. Specifically, FIGS. 8 and 9 illustrate aligning the interface 136 of the battery pack 126 with the receiving region 120 of the drill 100 and moving the battery pack 126 toward the receiving region 120 in the direction of arrow C. If the battery pack 126 includes the locking assembly 140 and actuator(s) 142, it may be desirable or necessary to depress the actuators 142 in the directions of arrows D as shown in FIG. 9. It will be understood that in no way is the present subject matter limited to any of the constructions or configurations depicted in the referenced figures. Instead, the present subject matter includes a wide array of configurations and assemblies for engaging a battery pack with a power tool and/or a charger.

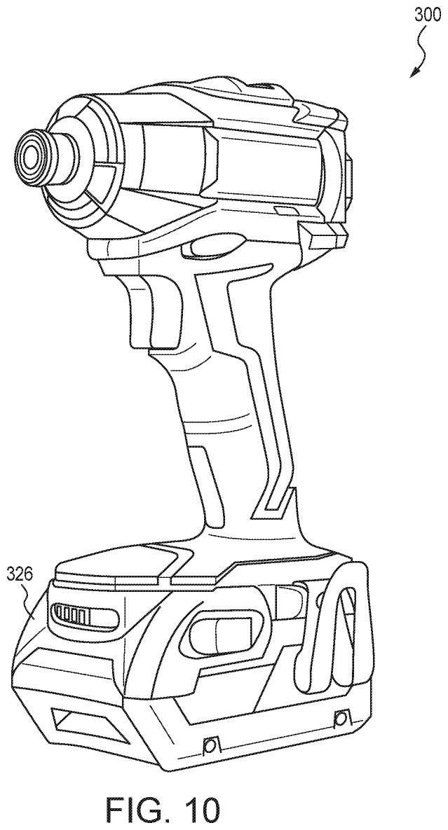

FIG. 10 illustrates another battery powered tool using an embodiment of a battery pack in accordance with the present subject matter. FIG. 10 shows a typical impact driver 300 engaged with a battery pack 326 in accordance with the present subject matter. The battery pack 326 is as described herein.

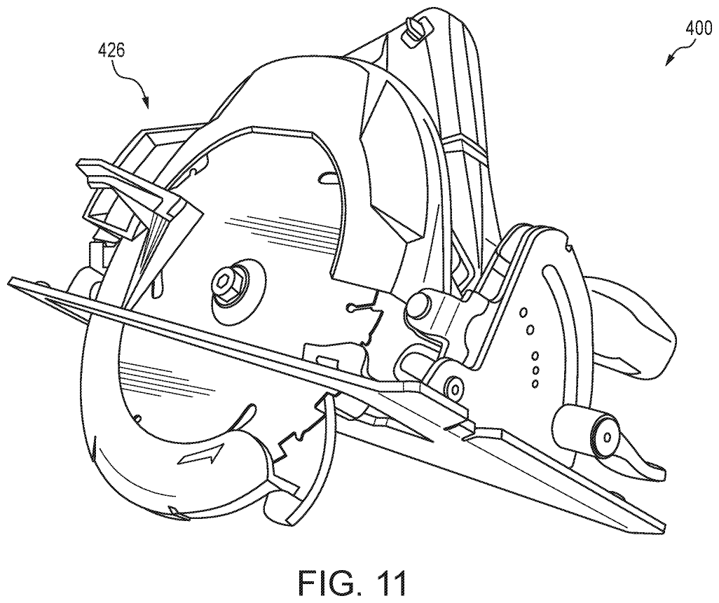

FIG. 11 illustrates another battery powered tool using an embodiment of a battery pack in accordance with the present subject matter. FIG. 11 shows a typical circular saw 400 engaged with a battery pack 426 in accordance with the present subject matter. The battery pack 426 is as described herein.

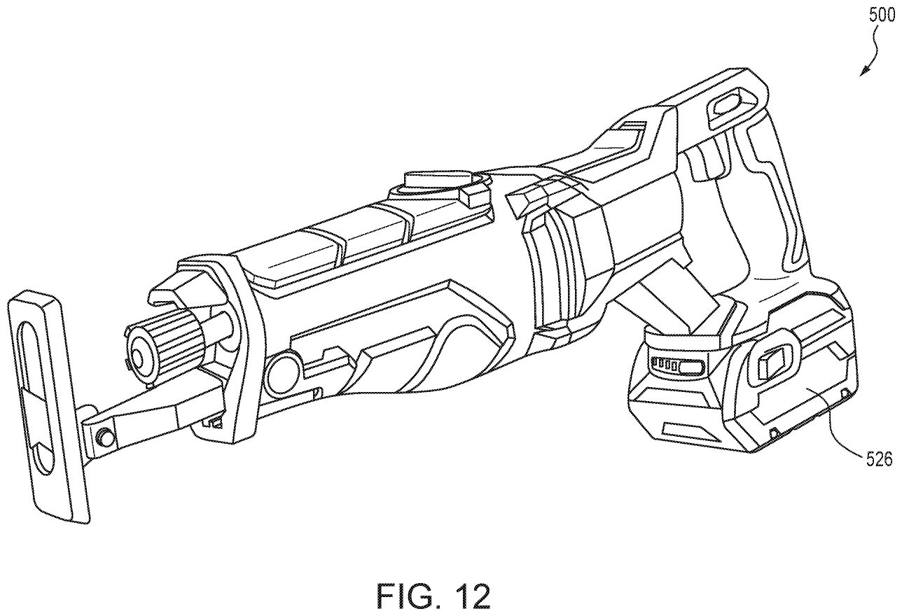

FIG. 12 illustrates another battery powered tool using an embodiment of a battery pack in accordance with the present subject matter. FIG. 12 shows a typical reciprocating saw 500 engaged with a battery pack 526 in accordance with the present subject matter. The battery pack 526 is as described herein.

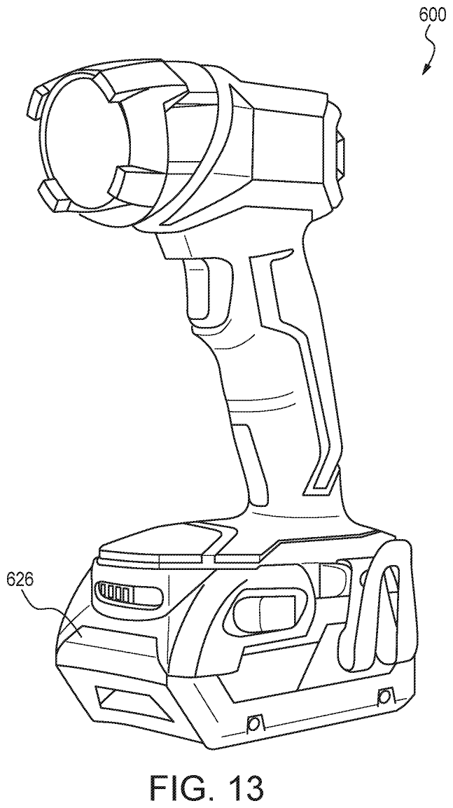

FIG. 13 illustrates another battery powered tool using an embodiment of a battery pack in accordance with the present subject matter. FIG. 13 shows a typical light 600 engaged with a battery pack 626 in accordance with the present subject matter. The battery pack 626 is as described herein.

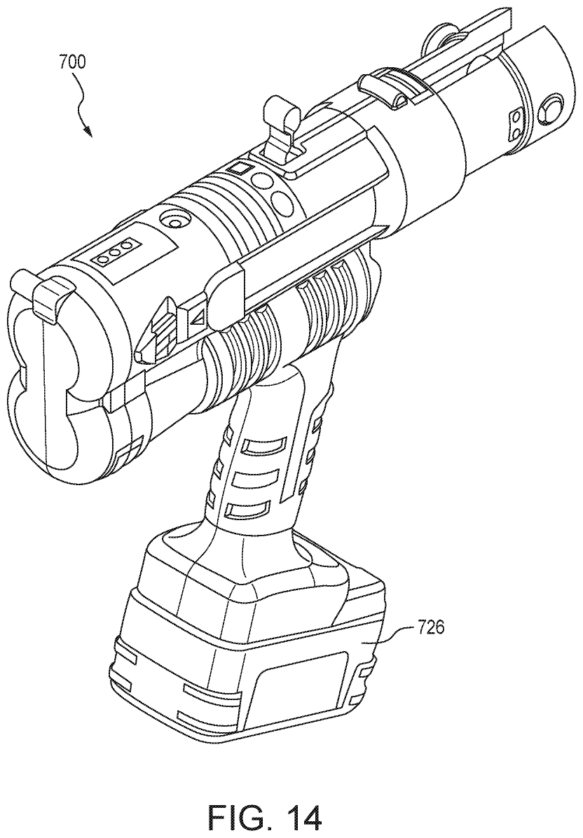

FIG. 14 illustrates another battery powered tool using an embodiment of a battery pack in accordance with the present subject matter. FIG. 14 shows a typical press tool 700 engaged with a battery pack 726 in accordance with the present subject matter. The battery pack 726 is as described herein.

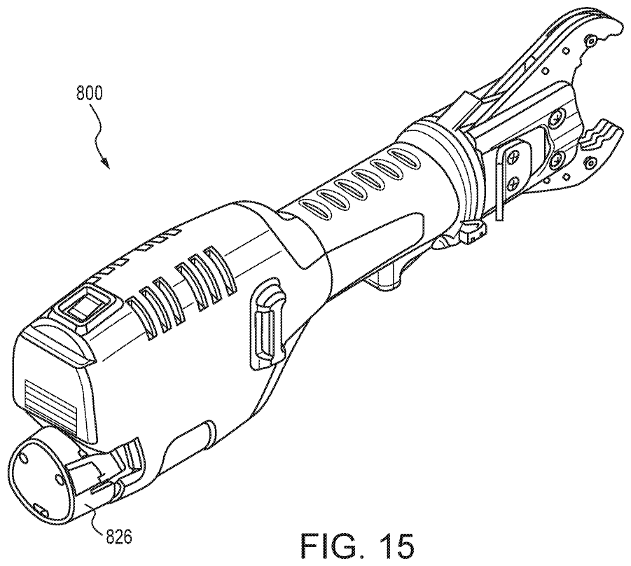

FIG. 15 illustrates another battery powered tool using an embodiment of a battery pack in accordance with the present subject matter. FIG. 15 shows another typical press tool 800 engaged with a battery pack 826 in accordance with the present subject matter. The battery pack 826 is as described herein.

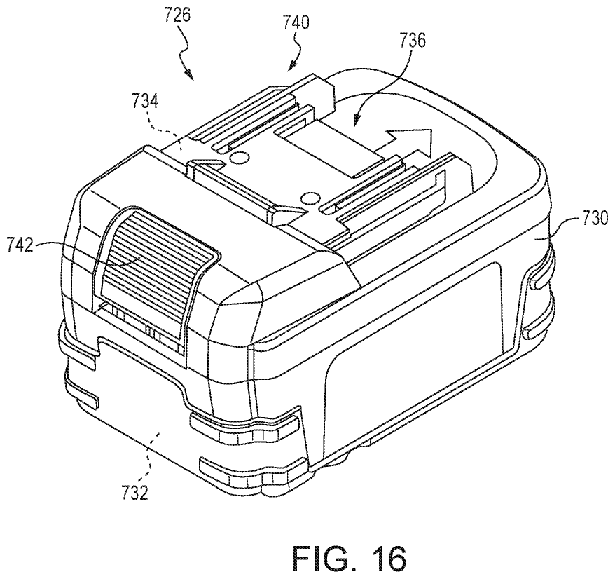

FIG. 16 illustrates the battery pack 726 depicted in FIG. 14. The battery pack 726 includes a housing 730, at least one lithium solid electrolyte battery cell 732 (not shown) disposed in the housing 730, electronic circuitry 734 (not shown) as previously described, and an interface 736 for engaging and electrically connecting the battery pack 726 to a tool. The battery pack 726 also includes a locking assembly 740 with optional actuators 742 as described herein.

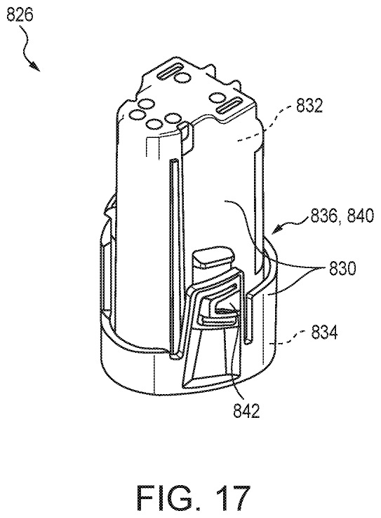

FIG. 17 illustrates the battery pack 826 depicted in FIG. 15. The battery pack 826 includes a housing 830, at least one lithium solid electrolyte cell 832 (not shown) disposed in the housing 830, electronic circuitry 834 (not shown) as previously described, and an interface 836 for engaging and electrically connecting the battery pack 826 to a tool. The battery pack 826 also includes a locking assembly 840 with optional actuators 842 as described herein.

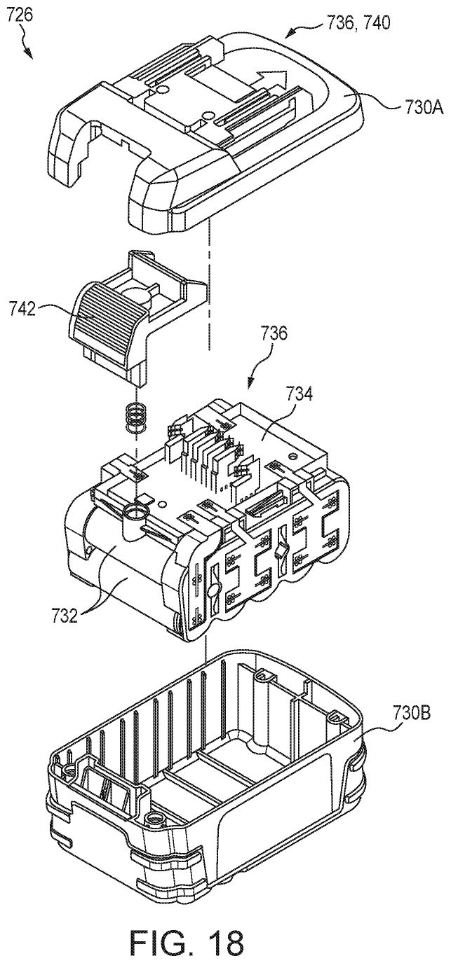

FIG. 18 is an exploded assembly view of the battery pack 726 of FIGS. 14 and 16. The housing 730 can be provided in a wide array of forms and configurations. FIG. 18 illustrates the housing 730 as including a first housing component 730A and a second housing component 730B which when engaged together provides a generally sealed interior region for the collection of cells 732.

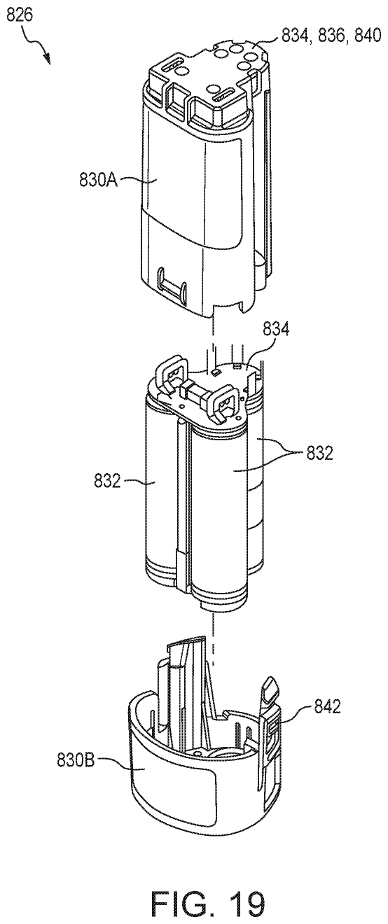

FIG. 19 is an exploded assembly view of the battery pack 826 of FIGS. 15 and 17. FIG. 19 illustrates the housing 830 as including first and second housing components 830A and 830B.

### Lithium Solid State Batteries

As used herein, the term “solid” refers to a non-flowable material. Typically, the term “solid” refers to a non-flowable material having a freestanding shape at room temperature. The term “solid electrolyte” as used herein with regard to the cells with lithium based chemistry, refers to a material having lithium ionic conductivity in which lithium ions migrate or are transported from one electrode to another. The solid electrolytes of the present subject matter are typically non-flowable at room temperature. The solid electrolytes of the present subject matter can be in a wide array of forms such as for example thin layers or laminates, particulate or powder form, bulk forms, and nearly any form necessary for the configuration of the cell and/or battery pack.

The lithium solid state electrolyte battery cell used in the battery packs of the present subject matter comprises a positive electrode, a negative electrode, and a solid electrolyte. The lithium solid state electrolyte battery cell may optionally also comprise a separator, which may include a microporous film.

An array of various materials can be used for the positive electrode and the negative electrode. These materials are solid. Typical non-limiting examples of materials for the negative electrode, i.e., the anode, include a wide array of publicly known electrode materials and more particularly alkali metals such as lithium, sodium, potassium, or combinations thereof. Particular non-limiting examples of the negative electrode material include metal indium, metal lithium, carbonaceous materials (for example, graphite or hard carbon), Li₄Ti₅O₁₂, Si, SiO, Sn, and SnO. Combinations of these materials can potentially be used with or without other materials.

Typical non-limiting examples of materials for the positive electrode, i.e., the cathode, include a wide array of publicly known electrode materials. Particular non-limiting examples of the positive electrode material include LiCoO₂, LiNiO₂, LiMn₂O₄, LiCoPO₄, LiMnPO₄, LiFePO₄, LiNiPO₄, and compounds obtained by substituting the transition metal of such a compound by one or two hetero elements (for example, LiNi_{1/3}Co_{1/3}Mn_{1/3}O₂, LiNi_{0.8}Co_{0.15}Al_{0.05}O₂, and LiNi_{0.5}Mn_{1.5}O₂). Combinations of these materials can potentially be used, with or without other materials.

The solid electrolytes used in the present subject matter can include a wide array of compositions. Non-limiting examples of solid electrolytes include ceramic materials such as lithium lanthanum zirconium oxide (LLZO). Various glass materials can be used such as ionic glass materials. And materials of lithium sulfide can potentially be used. Nonlimiting examples of solid electrolytes include Li₃Zr₂Si₂PO₁₂, Li₇La₃Zr₂O₁₂, Li₅La₃Ta₂O₁₂, Li_{1.5}Ti_{1.7}Al_{0.8}P_{2.8}Si_{0.2}O₁₂, La_{2/3-x}Li₃ₓTiO₃, Li₂S—SiS₂-based glass and glass ceramics, Li₂S—B₂S₃-based glass and glass ceramics, Li₂S—P₂S₅-based glass and glass ceramics, Li_{3.25}Ge_{0.25}P_{0.75}S₄, and Li₁₀GeP₂S₁₂. Other examples of the solid electrolyte include solid electrolytes obtained by adding an additive such as LiI or LiₓMO_{y} (M: P, Si, Ge, B, Al, Ga, or In; x, y: natural numbers) to the above-described examples. Examples of the solid electrolyte include inorganic solid electrolytes (sulfide solid electrolytes or oxide solid electrolytes).

### Optional Inorganic Particles

Inorganic particles may optionally be included in the solid electrolyte to improve barrier characteristics of the solid electrolyte. Barrier characteristics refer to the ability to block the passage of a gas and/or water vapor through the solid electrolyte. Inorganic particles dispersed in the solid electrolyte may form a tortuous path to inhibit diffusion of oxygen, so that the solid electrolyte may have barrier characteristics. Therefore, the solid electrolyte may be impermeable to a gas such as oxygen, thus the solid electrolyte may effectively protect the positive electrode, such as lithium metal, from the external environment.

The inorganic particle in the solid electrolyte may be electrochemically inert. That is, the electrochemically inert inorganic particle in the solid electrolyte is distinguished from an electrode active material. For example, the inorganic particle of the solid electrolyte is not oxidized or reduced during operation of the battery, and thus an oxidation number of the inorganic particle may not change due to intercalation and deintercalation of lithium ions or electrons. The inorganic particle of the solid electrolyte may include a non-carbonaceous inorganic particle and/or a nonmetallic inorganic particle. The inorganic particle of the solid electrolyte may be an electrical insulator. The inorganic particle of the solid electrolyte is distinguished from a conducting agent having electrical conductivity that is used in an electrode.

For example, the inorganic particle of the solid electrolyte may include at least one selected from a metal oxide, a metal nitride, a metal oxynitride, a metal carbide, a carbon oxide, a carbonaceous material, and an organic-inorganic composite. For example, the inorganic particle may include at least one selected from SiO₂, TiO₂, Al₂O₃, AIN, SiC, BaTiO₃, graphite oxide, graphene oxide, a metal organic framework (MOF), a polyhedral oligomeric silsesquioxane (POSS), Li₂CO₃, Li₃PO₄, Li₃N, Li₃S₄, Li₂O, and montmorillonite. However, embodiments are not limited thereto. Any inorganic particle suitable for use in a solid electrolyte may be used. The inorganic particle of the solid electrolyte may have a size of less than 100 nanometers (nm). For example, the inorganic particle of the solid electrolyte may have a size of less than or equal to about 50 nm, and in some embodiments, less than or equal to about 40 nm, and in some embodiments, less than or equal to about 30 nm, and in some other embodiments, less than or equal to about 2 nm. For example, the inorganic particle of the solid electrolyte may have a particle size of about 1 nm to about 80 nm, or about 2 nm to about 50 nm, or about 5 nm to about 20 nm. The term “particle size” as used herein, may refer to a diameter of the inorganic particle.

For example, the inorganic particle of the solid electrolyte may be a porous particle. For example, the inorganic particle may have a Brunauer-Emmett-Teller (BET) specific surface area of greater than or equal to about 300 square meters per gram (m²/g). For example, the inorganic particle may have a BET specific surface area of greater than or equal to about 400 m²/g, and in some embodiments, greater than or equal to about 500 m²/g, and in some embodiments, greater than or equal to about 600 m²/g, and in some other embodiments, greater than or equal to about 700 m²/g. In some embodiments, the inorganic particle of the solid electrolyte may be non-porous. For example, the inorganic particle of the solid electrolyte may have a spherical shape. However, the shape of the inorganic particle is not limited thereto. The inorganic particle may have any structure or shape that may facilitate an improvement in the barrier characteristics of the solid electrolyte. For example, the inorganic particle may be a non-porous spherical particle.

The advantages of the battery packs of the present subject matter for power tools over known batteries with liquid electrolytes are numerous and include improved safety since there is no flammable electrolyte, increased energy density (up to 3×), high charge/discharge rates up to 30 C as compared to 2 C for charging and 10 C for maximum discharge for conventional liquid electrolyte cells, long usable life since the formation of dendrites is avoided, and better usable temperature range.

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A battery pack for use with an electrically powered tool, the battery pack comprising:
a housing defining a generally hollow interior;
at least one lithium solid state electrolyte battery cell disposed in the hollow interior defined in the housing;
an interface for electrically connecting the battery pack to at least one of a tool and a charger.

2. The battery pack of claim 1 wherein the lithium solid state electrolyte battery cell includes:
a positive electrode;
a negative electrode; and
a solid electrolyte.

3. The battery pack of claim 2 wherein the cell further includes a separator and the separator includes a microporous film.

4. The battery pack of claim 1 further comprising:
electronic circuitry to control charging or discharging of the cell.

5. The battery pack of claim 1 wherein the battery pack can supply an average discharge current of at least 10 A.

6. The battery pack of claim 1 wherein the battery pack exhibits an ampere-hour capacity of at least 1 Ah.

7. The battery pack of claim 1 wherein the battery pack provides a peak output voltage within a range of from 3V to 120V.

8. The battery pack of claim 1 wherein the interface includes electrical contacts for transferring electrical power from the battery pack or electrical power to the battery pack.

9. The battery pack of claim 1 wherein the battery pack comprises at least two battery cells and the two battery cells are configured in a series arrangement.

10. The battery pack of claim 1 wherein the battery pack comprises at least two battery cells and the two battery cells are configured in a parallel arrangement.

11. The battery pack of claim 1 wherein the battery pack comprises a plurality of battery cells and a first portion of the plurality of battery cells are configured in a series arrangement and a second portion of the plurality of battery cells are configured in a parallel arrangement.

12. A system comprising:
at least one of an electrically powered device and a charger;
a battery pack including a housing defining a generally hollow interior, at least one lithium solid state electrolyte battery cell disposed in the hollow interior defined in the housing, and an interface for connecting the battery pack to both the electrically powered device and the charger, separately.

13. The system of claim 12 wherein the lithium solid state electrolyte battery cell includes a positive electrode, a negative electrode, and a solid electrolyte.

14. The system of claim 13 wherein the cell further includes a separator and the separator includes a microporous film.

15. The system of claim 12 wherein the battery pack can supply an average discharge current of at least 10 A.

16. The system of claim 12 wherein the battery pack exhibits an ampere-hour capacity of at least 1 Ah.

17. The system of claim 12 wherein the battery pack provides a peak output voltage within a range of from 3V to 120V.

18. The system of claim 11 wherein the electrically powered device is selected from the group consisting of rotary drivers, drills, saws, grinders, blowers, press tools, rotary hammers, lights, lawn mowers, lawn trimmers, edgers, hedge trimmers, and snow blowers.

19. The system of claim 12 wherein the battery pack further includes electronic circuitry to control charging of the cell.

20. The system of claim 12 wherein the battery pack further includes electronic circuitry to control discharging of the cell.

21. The system of claim 12 wherein the battery pack includes at least two battery cells and the two battery cells are configured in a series arrangement.

22. The system of claim 12 wherein the battery pack includes at least two battery cells and the two battery cells are configured in a parallel arrangement.

23. The system of claim 12 wherein the battery pack comprises a plurality of battery cells and a first portion of the plurality of battery cells are configured in a series arrangement and a second portion of the plurality of battery cells are configured in a parallel arrangement.
